(19) United States
(12) Patent Application Publication
(10) Pub. No.: US 2006/0120384 A1
(43) Pub. Date: Jun. 8, 2006

(54) Method and system for information gathering and aggregation in dynamic distributed environments

(75) Inventors: Irwin Boutboul, White Plains, NY (US); Dikran S. Meliksetian, Danbury, CT (US); Jean-Pierre Prost, Montpellier (FR); Nianjun Zhou, Somers, NY (US)

Correspondence Address: Sean F. Sullivan;Cantor Colburn LLP, 55 Griffin Road South, Bloomfield, CT, 06002, US

(73) Assignee: INTERNATIONAL BUSINESS MACHINES CORPORATION, ARMONK, NY (US)

(21) Appl. No.: 11/007,044

(22) Filed: Dec. 8, 2004

(51) Int. Cl. H04L 12/56

(52) U.S. Cl. 370/400

(57) ABSTRACT

A method for information gathering and aggregation in a dynamic distributed environment includes obtaining topology information identifying a plurality of topology nodes of the topology and communication paths of the plurality of topology nodes. An information services policy is obtained, and information gathering directives are determined for information gathering nodes included in the plurality of topology nodes and sent thereto, based on the obtained topology information and the obtained information services policy. Information aggregating directives are also determined for information aggregating nodes included in the plurality of topology nodes and sent thereto, based on the obtained topology information and the obtained information services policy.

### BACKGROUND

The present invention relates generally to control and management of a dynamic distributed environment of autonomous cooperating agents, and, more particularly, to a method and system for information gathering and aggregation in dynamic distributed environments, such as a grid computing environment.

Grid computing enables the virtualization of distributed computing and data resources such as processing, network bandwidth and storage capacity to create a single system image, granting users and applications seamless access to vast IT capabilities. Just as an Internet user views a unified instance of content via the Web, a grid user essentially sees a single, large virtual computer. At its core, grid computing is based on an open set of standards and protocols such as the Open Grid Services Architecture (OGSA), www.globus.org, and the Web Services Resource Framework (WS-RF), www.webservices.org, both or which are incorporated herein by reference. These standards enable communication across heterogeneous, geographically dispersed environments. With grid computing, organizations can optimize computing and data resources, pool them for large capacity workloads, and share them across networks for enabling collaboration. Further information regarding the Open Grid Services Architecture (OGSA), and grid computing in general, may be found in the publication entitled, “The Physiology of the Grid”, Ian Foster, Argonne National Laboratory & University of Chicago, Jul. 20, 2002, www.globus.org/research/papers/osga.pdf, the contents of which are incorporated herein by reference in their entirety.

A basic premise of OGSA and WS-RF is that everything may be represented by a service or may be accessed and managed through services (i.e., a network enabled entity that provides some capability through the exchange of messages). Computational resources, storage resources, networks, programs and databases are all examples of such services. More specifically, OGSA represents everything as a Grid service (i.e., a Web service that conforms to a set of conventions and supports standard interfaces for such purposes as lifetime management). This core set of consistent interfaces, from which all Grid services are implemented, facilitates the construction of higher order services that can be treated in a uniform way across layers of abstraction.

There are two common models currently used for control and management of a collective of independent entities, namely, the “centralized” model and the “hierarchical” model. In the centralized model, a central authority directly controls all the entities within the collective. Such a model is only feasible, however, if the size of the collective is limited. On the other hand, in the hierarchical model, the flow of control is mapped into a tree structure, wherein inner tree nodes have the responsibility of controlling their immediate children. In other words, each inner node directly controls only a limited number of entities (e.g., other inner nodes or leaf nodes). Although this model is more flexible in terms of the size of the collective, there are at least two limitations associated therewith.

First, the failure of an inner node immediately disconnects the sub-tree controlled by the failed inner node from the rest of the collective. Second, the hierarchical model is most efficient in a static environment, where all of the entities are known “a priori” and a balanced tree may be designed and implemented. However, in a dynamic environment (where entities constantly join and leave the collective), the maintenance of a balanced tree becomes more difficult. For example, some nodes will be forced to control an increasingly larger number of other entities, and eventually reaching a point where it becomes necessary to stop the operation of the collective and re-architect the hierarchical structure. Accordingly, it would be desirable to be able to implement a management structure that provides a scalable and resilient mechanism for propagating control information throughout a collective, such as a computing grid or an ad-hoc network of mobile nodes, for example.

Furthermore, the users of a computational grid need to know information concerning the available grid resources in order to best allocate tasks. Because resource availability and load conditions vary continuously in a grid environment, this information is therefore very dynamic and, as such, the information gathered from the various resources should be made available to users in manageable format. To this end, any information services topology associated with the grid environment should be scalable from both a data collection point of view and a client query point of view, so as to alleviate potential bottleneck problems caused by system data collection and client queries. Moreover, the information services topology should be able to provide the grid resource information in a timely, accurate manner for a large amount of data that is collected, indexed and updated frequently.

### SUMMARY

The foregoing discussed drawbacks and deficiencies of the prior art are overcome or alleviated by a method for information gathering and aggregation in a dynamic distributed environment. In an exemplary embodiment, the method includes obtaining topology information identifying a plurality of topology nodes of the topology and communication paths of the plurality of topology nodes. An information services policy is obtained, and information gathering directives are determined for information gathering nodes included in the plurality of topology nodes and sent thereto, based on the obtained topology information and the obtained information services policy. Information aggregating directives are also determined for information aggregating nodes included in the plurality of topology nodes and sent thereto, based on the obtained topology information and the obtained information services policy.

In another embodiment, a method for information gathering and aggregation in a dynamic distributed environment includes configuring a master node in an active topology wherein the active topology comprises nodes and intercommunication paths between the nodes. The nodes further include one or more leaf nodes having only incoming edges thereto, and configured to collect information about itself, one or more prime nodes having both incoming and outgoing edges, and configured to information received from other nodes to which each prime node subscribes, based on a predefined information services policy. One or more root prime nodes have only outgoing edges, and are configured to aggregate and index information received from other nodes to which each root prime node subscribes. The master node further includes an automated topology formation application having a predefined topology policy definition and a representation of the active topology.

Collected information is transmitted from a configured leaf node to a subscribing prime node, the collected information being collected according to a collecting directive, and transmitted according to a predetermined schedule. The transmitted collected information is received at a first configured prime node and aggregated with collected information received from one or more other configured leaf nodes. When the first configured prime node is subscribed to by a second configured prime node, the aggregated information is transmitted to the second configured prime node according to a predetermined schedule. When the first configured prime node is subscribed to by a second configured prime node, the information is aggregated at the second configured prime node with information received from other nodes subscribed to by the second configured prime node. When an aggregating step detects a predefined topology affecting event, a topology event notification is transmitted to the master node, the event notification indicating an event affecting the active topology. The automated topology formation application determines that the topology event notification affects a topology portion of the active topology, and based on the topology event notification, the representation of the affected topology portion of the active topology is modified according to the predefined topology policy definition.

### BRIEF DESCRIPTION OF THE DRAWINGS

Referring to the exemplary drawings wherein like elements are numbered alike in the several Figures:

FIG. 1 is a schematic diagram of a representative workstation or server hardware system in which the present invention may be practiced;

FIG. 2 is a schematic diagram of a data processing network in which the present invention may be practiced;

FIGS. 3A, 3B and 3C are block diagrams illustrating automated topology formation in a dynamic, distributed environment, under various scenarios;

FIGS. 4 and 5 are flow diagrams of an exemplary embodiment of the execution of an application included within an entity associated with the topology;

FIG. 6 is a diagram of an exemplary topology created in accordance with the method shown in FIG. 3, particularly illustrating the relationship between nodes, prime nodes and the master node;

FIG. 7 is a diagram of another exemplary hierarchical topology created in a grid computing environment, particularly illustrating the relationship between hosts, primes, and the root prime;

FIG. 8 is a schematic diagram of an exemplary information services topology created in accordance with an embodiment of the invention; and

FIG. 9 is a schematic diagram illustrating an example of the data aggregation capability of the information services topology.

### DETAILED DESCRIPTION

Disclosed herein is a method and system for information gathering and aggregation in dynamic distributed environments (such as a grid computing environment), in which there is provided a self-configurable, scalable, reliable, and secure distributed information services topology that features efficient and adaptable information services. As opposed to a concatenated approach, the individual grid resource data is aggregated at each subscription level, using a desired level of granularity. In this regard, each grid resource (node) provides, at least, primitive data about itself. If the node is also a prime node, then it also receives primitive data about leaf nodes to which the prime node subscribes and/or aggregated data from other prime nodes to which the prime node subscribes.

In an exemplary embodiment, the information services topology described hereinafter is implemented within a dynamic distributed environment characterized by a self-configuring, acyclic graph structure in which each entity receives control information from multiple parent nodes. Moreover, the selection of the parent nodes is dynamic, thus allowing for on-line “morphing” of the acyclic graph as new entities join the collective or as existing entities leave the collective. Thus configured, the topology formation system provides a scalable and resilient mechanism for propagating control information throughout a collective, such as a large, distributed grid infrastructure. Furthermore, the graph structure allows for configuration software deployment, policy management, information services deployment and querying within a distributed grid infrastructure. Additional information concerning topology formation is presented in Attorney Docket Number POU9-2004-0064US1, filed concurrently herewith, and the contents of which are incorporated herein by reference in their entirety.

As further discussed herein, entities (e.g., grid resources) are organized in a global acyclic directed graph, wherein each resource on the grid is a node of the graph. The distributed environment automatically configures itself, based on pre-specified policies, into a topology. Examples of distributed environments that would benefit from this scheme include, but are not limited to, computational grids, peer-to-peer networks, and ad-hoc mobile networks. The resulting system thus is highly dynamic and resilient to variation in node status, location. Thus configured, information may be propagated within the graph, using the distributed structure provided thereby, instead of having a 1 to n (main server and n clients) managed architecture. A resource may be either a simple resource (leaf node) or a “prime,” wherein a prime is a resource in the graph that acts as an information aggregator or information compactor node. In this regard, the prime gathers information from other primes or from simple resources, compacts the gathered information and forwards it to other primes.

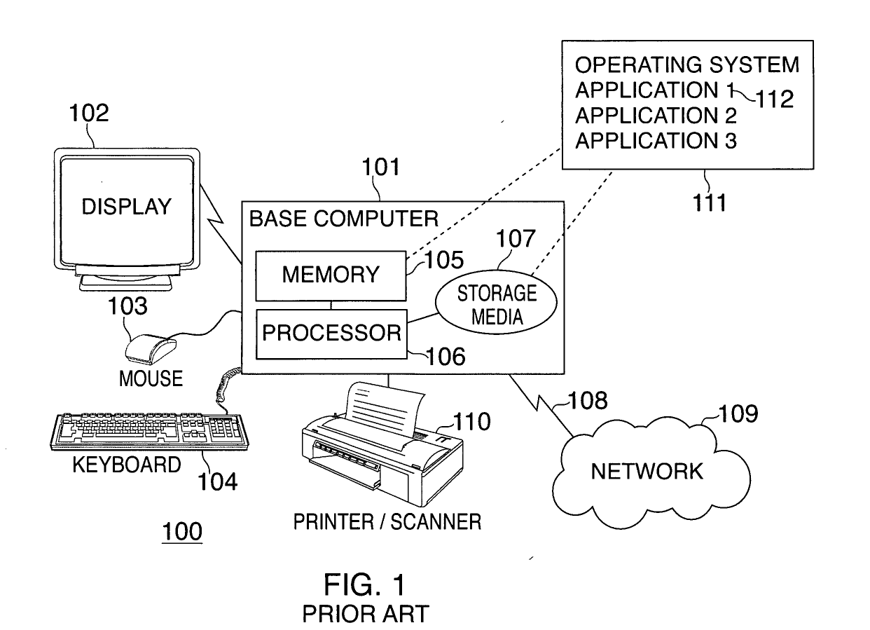

Referring to FIG. 1, there is shown a representative workstation or server hardware system 100 in which the present invention may be practiced. The system 100 of FIG. 1 comprises a representative computer system 101, such as a personal computer, a workstation or a server, including optional peripheral devices. The workstation 101 includes one or more processors 106 and a bus employed to connect and enable communication between the processor(s) 106 and the other components of the system 101 in accordance with known techniques. The bus connects the processor 106 to memory 105 and long-term storage 107 which can include a hard drive, diskette drive or tape drive for example. The system 101 might also include a user interface adapter, which connects the microprocessor 106 via the bus to one or more interface devices, such as a keyboard 104, mouse 103, a printer/scanner 110 and/or other interface devices, which can be any user interface device, such as a touch sensitive screen, digitized entry pad, etc. The bus also connects a display device 102, such as an LCD screen or monitor, to the microprocessor 106 via a display adapter.

The system 101 may communicate with other computers or networks of computers by way of a network adapter capable of communicating with a network 109. Exemplary network adapters are communications channels, token ring, Ethernet or modems. Alternatively, the workstation 101 may communicate using a wireless interface, such as a CDPD (cellular digital packet data) card. The workstation 101 may be associated with such other computers in a Local Area Network (LAN) or a Wide Area Network (WAN), or the workstation 101 can be a client in a client/server arrangement with another computer, etc. All of these configurations, as well as the appropriate communications hardware and software, are known in the art.

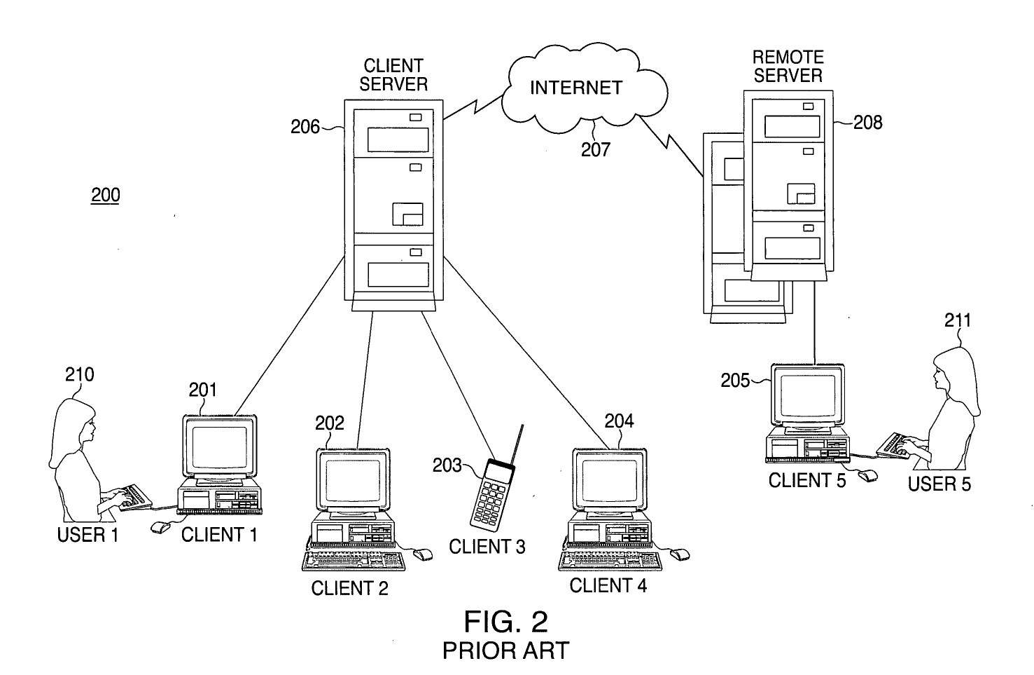

FIG. 2 illustrates a data processing network 200 in which the present invention may be practiced. The data processing network 200 may include a plurality of individual networks, such as a wireless network and a wired network, each of which may include a plurality of individual workstations 101. Additionally, as those skilled in the art will appreciate, one or more LANs may be included, where a LAN may comprise a plurality of intelligent workstations coupled to a host processor.

Still referring to FIG. 2, the networks may also include mainframe computers or servers, such as a gateway computer (client server 206) or application server (remote server 208 which may access a data repository). A gateway computer 206 serves as a point of entry into each network 207. A gateway is needed when connecting one networking protocol to another. The gateway 206 may be preferably coupled to another network (the Internet 207 for example) by means of a communications link. The gateway 206 may also be directly coupled to one or more workstations 101 using a communications link. The gateway computer may be implemented utilizing an IBM eServer zServer 900 Server available from IBM.

Software programming code that embodies the present invention is typically accessed by the processor 106 of the system 101 from long-term storage media 107, such as a CD-ROM drive or hard drive. The software programming code may be embodied on any of a variety of known media for use with a data processing system, such as a diskette, hard drive, or CD-ROM. The code may be distributed on such media, or may be distributed to users from the memory or storage of one computer system over a network to other computer systems for use by users of such other systems.

Alternatively, the programming code 111 may be embodied in the memory 105, and accessed by the processor 106 using the processor bus. Such programming code includes an operating system, which controls the function and interaction of the various computer components and one or more application programs. Program code is normally paged from dense storage media 107 to high speed memory 105 where it is available for processing by the processor 106. The techniques and methods for embodying software programming code in memory, on physical media, and/or distributing software code via networks are well known and will not be further discussed herein.

In one embodiment, the present invention is implemented as one or more computer software programs 111. The implementation of the software of the present invention may operate on a user's workstation, as one or more modules or applications 111 (also referred to as code subroutines, or “objects” in object-oriented programming), which are invoked upon request. Alternatively, the software may operate on a server in a network, or in any device capable of executing the program code implementing the present invention. The logic implementing this invention may be integrated within the code of an application program, or it may be implemented as one or more separate utility modules which are invoked by that application, without deviating from the inventive concepts disclosed herein. The application 111 may be executing in a Web environment, where a Web server provides services in response to requests from a client connected through the Internet. In another embodiment, the application may be executing in a corporate intranet or extranet, or in any other network environment. Configurations for the environment include a client/server network, Peer-to-Peer networks (wherein clients interact directly by performing both client and server function) as well as a multi-tier environment. These environments and configurations are well known in the art.

Certain features characteristic of a dynamic distributed environment (and to which the present invention embodiments are particularly applicable), include for example, that:

the number of entities is large;

the participation of entities in the environment changes dynamically;

entities within the environment might unexpectedly become unreachable;

the individual entities have a limited a priori knowledge about the environment;

the entities have no a priori knowledge about one another;

the entities have limited trust with one another; and

there are no security guarantees within the environment.

In the specific case of computational grids, the “entities” are the resources that make up the grid, and the purpose of forming the topology may be (for example) to provide a distributed management overlay or an information gathering and distribution overlay.

Regardless of the specific type dynamic distributed environment involved, the formation of a topology is based on a policy. In addition, multiple topologies, each abiding to a different policy, may be formed within a given distributed environment. Moreover, these topologies can coexist and operate simultaneously. For example, in an ad-hoc mobile network, it might be useful to define a topology consisting of a minimal spanning tree for transferring voice data, and to simultaneously define a reliable topology where there are at least two independent paths between every pair of nodes for transferring critical text data.

Topology Characteristics

As indicated previously, the individual entities of the collective are associated in a global acyclic directed graph. In an exemplary embodiment, each entity of the collective is a node of the graph, wherein two nodes of the graph have an edge between the two if their role in the topology requires a direct communication therebetween. A specific entity within the distributed environment (referred to herein as the master node) performs the topology formation. Nodes that have only incoming edges are referred to as leaf nodes, while nodes that have both incoming and outgoing edges are referred to as primes. Nodes that have only outgoing edges are referred to as roots, wherein the graph may include more than one root therein.

The master node, while responsible for the creation of the graph topology, need not necessarily serve a distinguished role in the graph, and may be either a root, prime, or leaf node. Furthermore, each topology has an associated naming scheme therewith. One example of such a naming scheme may be to label each node as a path of nodes interconnecting the master node thereto. It will be noted that the naming itself is not unique, since in the acyclic graph there might be multiple paths between the master node and any other given node.

Topology Formation and Evolution

As mentioned earlier, the task of topology formation is performed by the master node. Each entity in the distributed environment has a native mechanism for participating in the topology formation process, and for becoming a part of the topology itself. In the case of a service based computational grid, this might be implemented as a grid service (e.g., the Topology Formation Service) such that each grid resource is configured to deploy by default at initiation time.

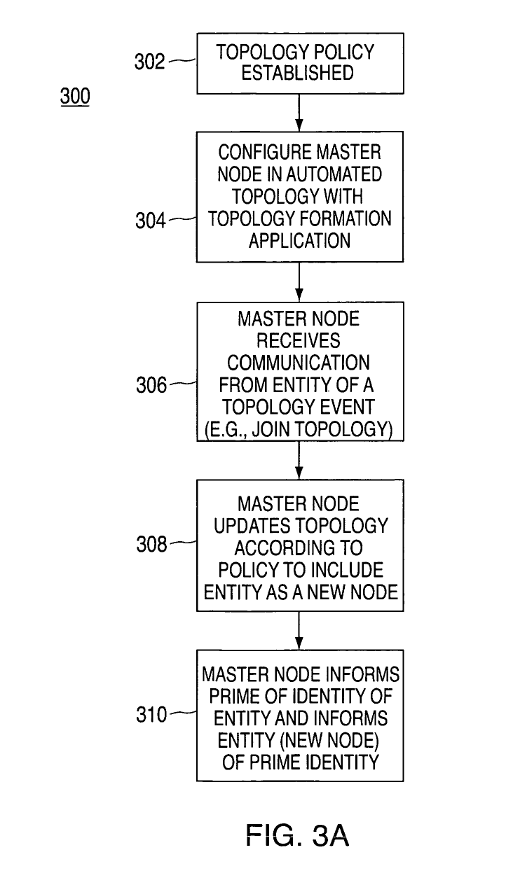

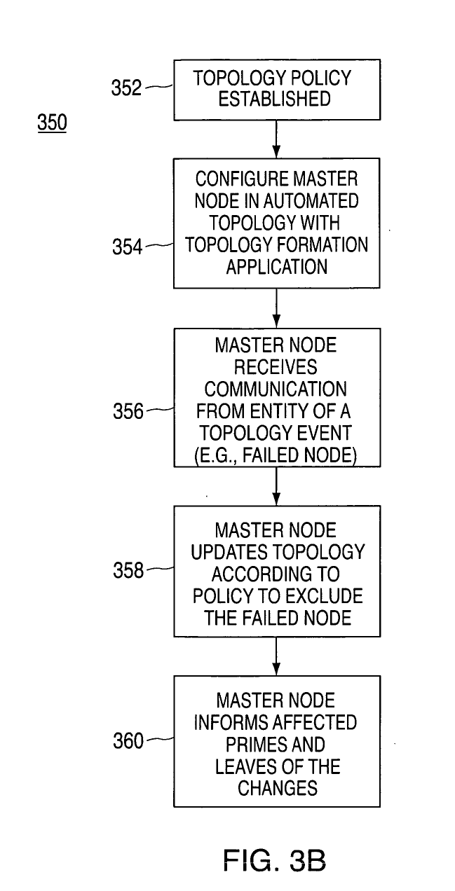

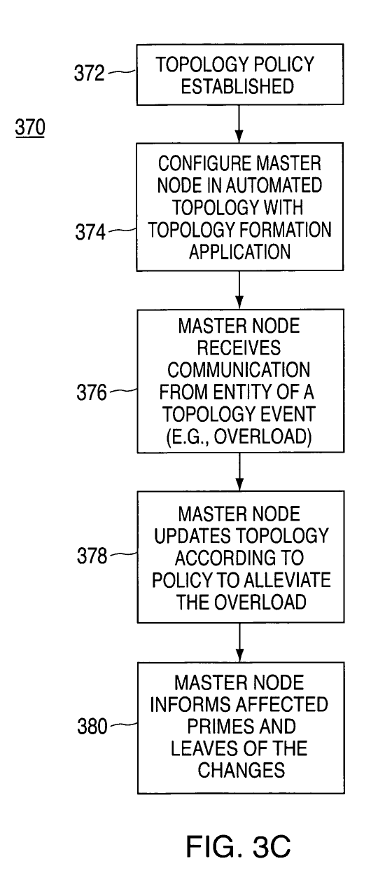

Referring now to FIG. 3A, there is shown a block diagram 300 of an exemplary process sequence for automated topology formation in a dynamic, distributed environment, illustrating a specific example of a node to be added to the topology. As indicated in block 302, a predefined topology policy is in place, according to which entities are joined to, maintained within, and/or removed from the topology. Initially, the master node is configured in an automated topology, with a topology formation application, as shown at block 304. As shown in block 306, the master node receives a communication from an entity of a topology event (in this example, a request from the entity to join the topology). The master node then uses its automated topology application to update the topology (in accordance with the topology policy) to include this new entity as a node in the environment, as shown in block 308. In so doing, the master node may take one or more of the following actions:

(1) The master node determines one or more prime nodes that will act as prime nodes for the new entity.

(2) The master selects a leaf node, promotes it to the status of prime node and assigns this new prime node to act as a prime node for the new entity.

(3) The master node reshuffles a portion of the graph and determines a new topology for that portion that includes the new entity.

(4) The master node scraps the existing topology and builds a completely different topology that incorporates the new entity.

The determination of which particular actions to perform in selecting new prime nodes and updating the topology is based on the policy for the particular topology. In turn, the factors upon which the topology formation policy depend may include one of more of the following:

the expected task or tasks performed by the prime nodes;

the capabilities and potentials of the nodes (wherein “capabilities” refer to the services offered by the node and “potential” refers to the hardware features);

the capabilities of the communication network(s) interconnecting the nodes;

the desired security of the topology;

the desired reliability of the topology; and

the desired performance of the topology.

By way of example, a sample topology policy for the dynamic distributed environment could provide for the following:

(1) prime nodes are to have no more than 10 children nodes;

(2) the network distance between a prime node and its child is less than 5 hops; and

(3) a prime node having less than 2 nodes associated therewith is decommissioned unless such a decommissioning results in a violation of rule (2).

Referring again to FIG. 3A, and as shown in block 310, each time the master node assigns a prime to a new entity, it informs the prime of the identity of the new entity. The master node also informs the new entity of the prime identity. The prime and the new entity then interact in order to perform the task specified in the topology related service.

Referring now to FIG. 3B, there is shown a block diagram 350 illustrating a method for automated topology formation in a dynamic, distributed environment, in accordance with an embodiment of the invention (for a specific example of a node failure or node removal). As indicated in block 352, a predefined topology policy is in place, according to which entities are joined to, maintained within, and/or removed from the topology. Initially, the master node is configured in an automated topology, with a topology formation application, as shown at block 354. As shown in block 356, during normal operations, when an entity detects the failure or the absence of another entity, the master node receives a communication of this topology event from the entity and informs it of the situation. The master node then uses its automated topology application to update the topology (in accordance with the topology policy) to exclude the identified failed entity from the environment, as shown in block 358. In so doing, the master node may take one or more of the following actions:

(1) If the failed node is a leaf node:
(a) The master leaves the topology as is.
(b) The master node reshuffles a portion of the graph and determines a new topology for that portion that excludes the failed leaf node.
(d) The master node scraps the existing topology and builds a completely different topology that excludes the failed leaf node.

(2) If the failed node is a prime node:
(a) The master node determines one or more prime nodes that will take over the duties of the failed prime.
(b) The master selects a leaf node, promotes it to the status of prime node and assigns this new prime node the duties of the failed prime.
(c) The master node reshuffles a portion of the graph and determines a new topology for that portion that excludes the failed entity.
(d) The master node scraps the existing topology and builds a completely different topology that excludes the failed entity.

The determination of which particular actions to perform in selecting new prime nodes and updating the topology is based on the policy for the particular topology. In turn, the factors upon which the topology formation policy depend may include one of more of the following:

the expected task or tasks performed by the prime nodes;

the capabilities and potentials of the nodes (wherein “capabilities” refer to the services offered by the node and “potential” refers to the hardware features);

the capabilities of the communication network(s) interconnecting the nodes;

the desired security of the topology;

the desired reliability of the topology; and

the desired performance of the topology.

Referring again to FIG. 3B, and as shown in block 360, each time the master node changes the topology, it informs the affected primes and leaf nodes of the changes and the new relationships. The nodes then interact in order to perform the task specified in the topology related service.

Referring now to FIG. 3C, there is shown a block diagram 370 illustrating a method for automated topology formation in a dynamic, distributed environment, in accordance with another embodiment of the invention (for a specific example of a node experiencing an “overload” condition, where the overload condition refers to the amount of work that the node has to perform to maintain the topology compared with other duties of that node). As indicated in block 372, a predefined topology policy is in place, according to which entities are joined to, maintained within, and/or removed from the topology. Initially, the master node is configured in an automated topology, with a topology formation application, as shown at block 374. As shown in block 376, during normal operations, when an entity detects an overload condition, the master node receives a communication of this topology event from the entity and informs it of the situation. The master node then uses its automated topology application to update the topology (in accordance with the topology policy) to alleviate the overload from the environment, as shown in block 378. In so doing, the master node may take one or more of the following actions:

(1) The master node determines one or more prime nodes that will share the duties of the overloaded prime.

(2) The master selects a leaf node, promotes it to the status of prime node and assigns this new prime node some of the duties of the overloaded prime.

(3) The master node reshuffles a portion of the graph and determines a new topology for that portion that balances the load.

(4) The master node scraps the existing topology and builds a completely different topology that balances the load.

The determination of which particular actions to perform in selecting new prime nodes and updating the topology is based on the policy for the particular topology. In turn, the factors upon which the topology formation policy depend may include one of more of the following:

the expected task or tasks performed by the prime nodes;

the capabilities and potentials of the nodes (wherein “capabilities” refer to the services offered by the node and “potential” refers to the hardware features);

the capabilities of the communication network(s) interconnecting the nodes;

the desired security of the topology;

the desired reliability of the topology; and

the desired performance of the topology.

Referring again to FIG. 3C, and as shown in block 380, each time the master node changes the topology, it informs the affected primes and leaf nodes of the changes and the new relationships. The nodes then interact in order to perform the task specified in the topology related service.

At any given time, the master node can contact the Topology Formation Service of any entity to convert a simple entity into a prime. Once an entity is converted to a prime, it then deploys the Prime Management Service and is ready to act as a prime. Similarly, the master node may request the Topology Formation Service of any prime to undeploy the Prime Management Service. However, before removing a selected prime from the topology, the master node first reassigns the entities previously reporting to the selected prime to another prime.

The distributed environment is further provided with the capability of monitoring the proper functioning of the Topology Formation Services. As the system detects malfunctioning entities, it will update the topology to fulfill the policy requirements.

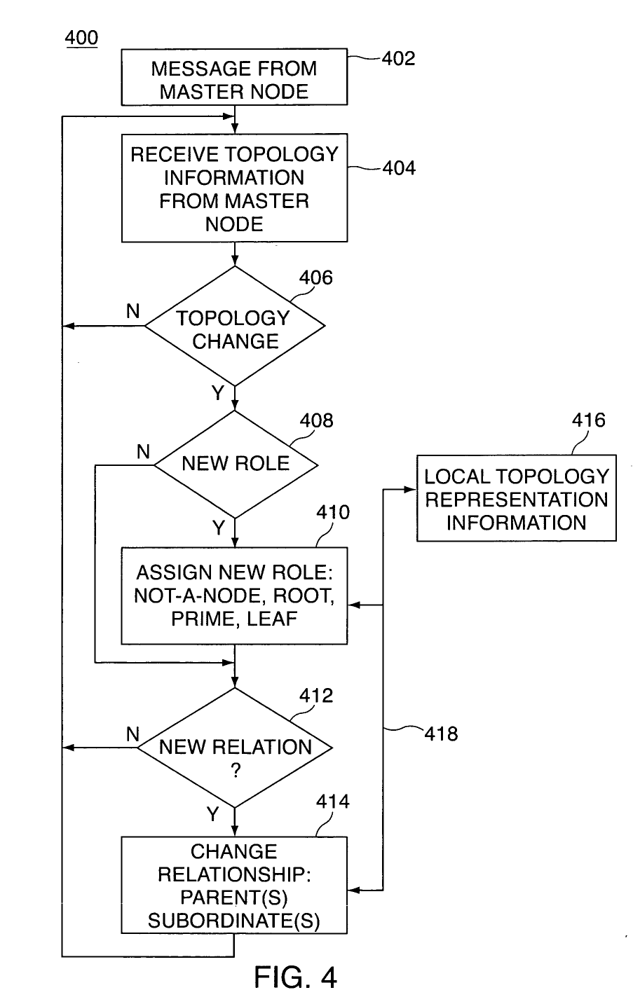

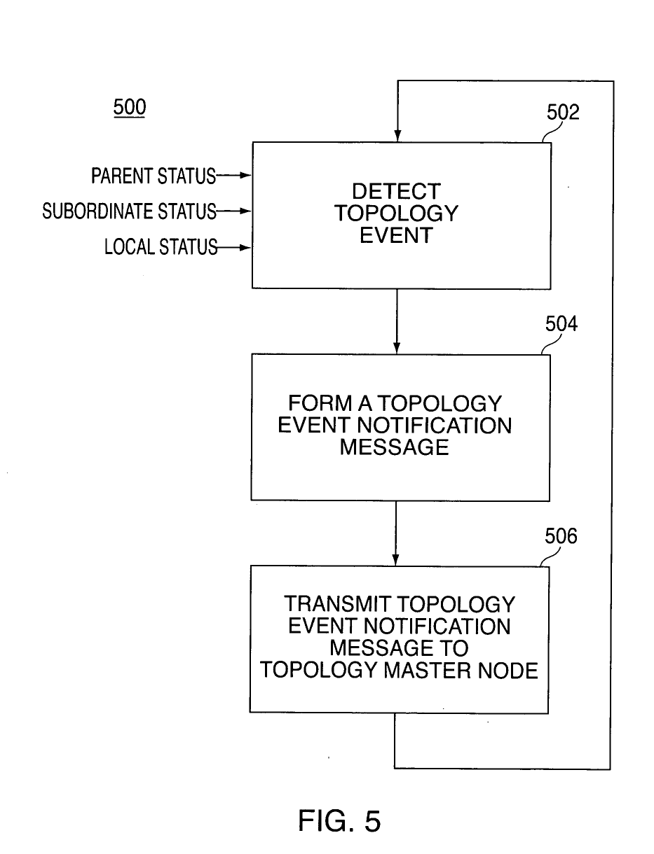

FIGS. 4 and 5 further illustrate the topology formation process from the perspective of the entity, which includes application software therein. The flow diagram 400 of FIG. 4 is illustrative of an exemplary embodiment of the execution of the application included within the entity. As shown in block 402, the entity receives a message from the master node, which may include topology information from the master node as indicated in block 404. At decision block 406, if the received topology information from the master node does not include a change in topology, the process returns to block 404. On the other hand, if the topology information received from the master node does contain a topology change, it is then determined at decision block 408 whether the entity is assigned a new role with respect to an initial topology role thereof. In the event a new role is to be assigned to the entity, the proceeds to block 410 for the new role assignment. As is shown, the new role may be one of: “not-a-node”, “root”, “prime” and “leaf.”

An entity is assigned a “not-a-node” topology role when it is not part of the topology (e.g., it was not previously part of the topology or it is newly removed from the topology. Moreover, a topology affecting event notification may be initiated by an entity that is not affected by the event. For example, an entity discovers that another entity is not responding to a communication, wherein the other entity may not be a parent or subordinate to the entity notifying the master node of the event. Entities may be identified by methods known in the art including, but not limited to: a MAC address, an IP address, a URL, a fully qualified host name or an RFID. The topology of an entity is defined in part by the topology role and the identities of any parent entities and subordinate entities associated with it.

If the topology change does not result in a new (updated) topology role for the entity, then the process proceeds to decision block 412 to see whether the topology change results in a change in relationship (e.g., parent/child) for the entity. If this is not the case, then the process returns to block 404. However, if there is a relationship change with respect to the entity, then the entity's application will reflect this change, as shown in block 414, and the process will finally return to block 404. As is further shown in FIG. 4, both the entity's role and relationships with respect to the topology may also be represented locally therein, as shown in block 416 and communication path 418.

In addition to receiving a communication from the master node, FIG. 5 also illustrates another function 500 of the entity, in terms of detecting topology events and informing the master node of the same. As shown in block 502, the application software within the entity is configured to detect a topology event (e.g., topology addition, subtraction, overload condition or failure). In detecting the topology event, the entity has access to information concerning the status of any parent associated therewith, any subordinates (children) thereof, as well as its own local status. A topology event notification message is formed in block 504, and transmitted to the master node in block 506, the cycle repeating thereafter for each new topology event.

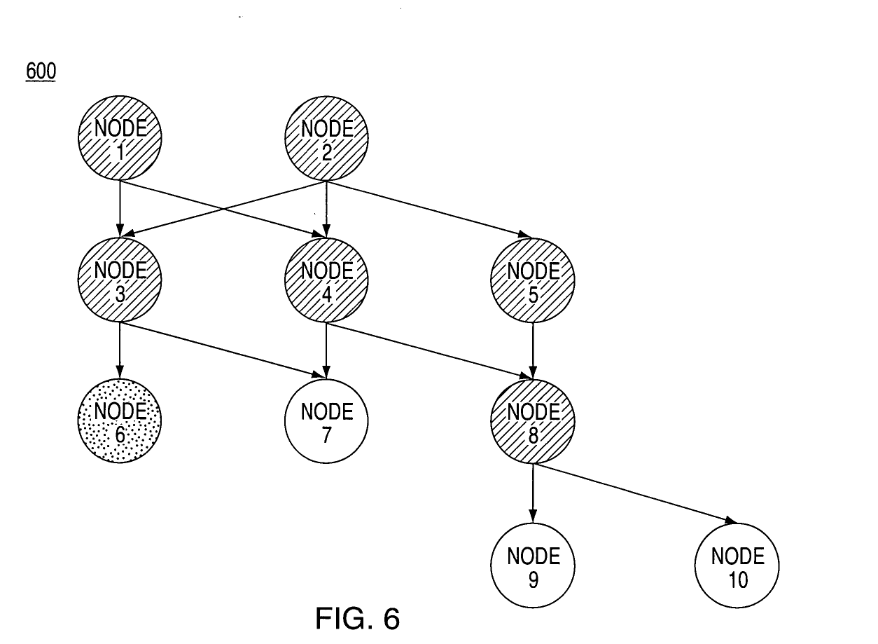

FIG. 6 illustrates an example of a created topology 600 for a distributed environment having 10 nodes. In the example depicted, nodes 6, 7, 9, and 10 are considered leaf nodes, while nodes 1, 2, 3, 4, 5 and 8 are prime nodes. In addition, node 6 is the master node for the exemplary topology. The master node 6 is known a priori by all other nodes but need not play a special role in the formed topology (as particularly illustrated in FIG. 6, since master node 6 is a leaf node). The naming scheme is based on the master node 6. It is further noted that nodes 1 and 2 are root nodes and, as such, play a special role in the topology (i.e., supporting queries concerning the entire topology).

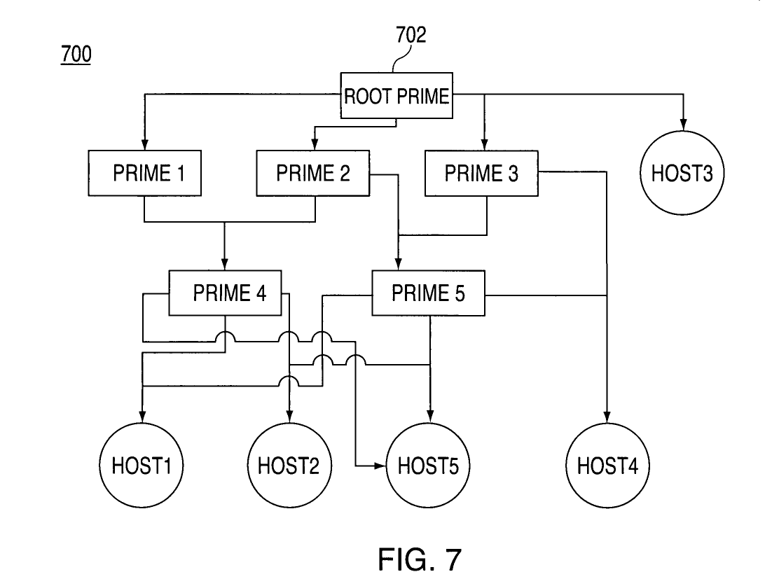

FIG. 7 illustrates a more specific example of a topology 700 formed in an OGSA (Open Grid Services Architecture) based grid. The goal of forming such a topology is to provide a scalable and resilient mechanism to propagate control information throughout the grid. Again, information is propagated in the graph using its distributed structure, instead of having a 1 to n (one server and n clients) managed architecture. In the simple example depicted, the root prime node 702 is a node that serves as both the master node (topology formation) and the main management node. The other prime nodes (Prime 1-Prime 5) are resources in the graph that act as “light management” or secondary management nodes by forwarding management requests down the graph, either to other primes or to simple resources (hosts). For communication between the nodes, subscription-notification mechanisms are used. In an exemplary embodiment, the subscription-notification mechanisms specified in the OGSI (Open Grid Services Infrastructure) can be used. In another embodiment, the mechanisms specified by WS-Notification can be utilized. Each resource subscribes to either two primes or to the Root Prime.

Because the root prime 702 is also the master node, it therefore performs the topology formation process. Each resource on the grid has a Topology Formation Service that trusts only the root prime 702. Upon startup, the new grid resource contacts the root prime to determine where to “plug in” to the tree. The root prime then performs the following tasks, in accordance with the predefined policy:

(1) The root prime selects two primes (or only one, itself) for the new resource.

(2) The root prime notifies the selected primes of the identity of the new resource that will subscribe to the selected primes.

(3) The root prime informs the new resource of the name(s) of the selected prime(s).

At any time, the root prime may contact the Topology Formation Service of any simple resource (which trusts only the root prime) and instruct it to deploy the Prime Management Service. The newly appointed prime then deploys the Prime Management Service and is ready to act as a prime. In the same manner, the Root Prime can also contact the Topology Formation Service to undeploy the Prime Management Service. Before removing a particular prime, P, from the tree, the root prime first removes all the children of P, and reassigns them to another prime. The root prime then removes prime P from the topology and alerts the previous primes of P that the role of P has changed.

Security Considerations

The security model of the FIG. 7 topology is based on PKI (Public Key Infrastructure). Each resource on the grid trusts the root prime certificate, and only the root prime is allowed to assign subscribers to each node of the tree. Furthermore, a resource will only accept to subscribe to a prime if it was assigned by the root prime. Correspondingly, a prime will only accept a subscriber if it was told to do so by the root prime.

Failure Detection

A mechanism for monitoring the system and detecting node failures, overload situations and other unexpected events is also provided. In an exemplary embodiment, each prime sends keep-alive pings to its subscribers. If a subscriber does not receive pings from one of its primes, it alerts the root prime, by contacting the Failure Service. If a subscriber receives notifications from one of its primes and not the other, it also alerts the root prime. Once the root prime is alerted of a failure by a subscriber, it reacts accordingly by selecting new primes for the resource and updating the topology according to the active policy. In other embodiments, this function may be accomplished by constantly polling the primes for their availability and their load condition. This could be accomplished, for example, through scheduled polling.

Information Services

Grid information services provide critical information that drives resource discovery and policy based resource selection in a grid environment. As such, it is essential that these services be scalable and reliable. Today, most grid information systems rely on a statically directed graph of data collectors. Data collectors typically gather all the information from other data collectors to which they are linked in this static topology. Data caching is also used by data collectors to improve performance. However, the scalability of this approach is limited since data transfer sizes between collectors is growing linearly with the number of hops, going up the directed graph. Moreover, fault tolerance is also an issue since the failure of a collector along the way may prevent the discovery or selection of the resources that are linked thereto, either directly or indirectly.

Accordingly, the method embodiments described herein present a new architecture for the formation of a self-adaptive and self-organizing hierarchical topology with multiple roots. In the present architecture, each grid node collects information about itself, while some grid nodes are elected at run time to be data aggregators. Each collector or aggregator reports its information to a higher level aggregator (up to one of the roots) through a publish-subscribe mechanism. The failure of an aggregator is automatically detected by the collectors or aggregators of the corresponding lower level. This in turn triggers the selection of a substitute aggregator and the reorganization of the topology. For scalability purposes, data is not only aggregated, but also reduced at each level, according to a user scheme specified for each collected data type.

As indicated previously, each resource (grid node) maintains the capability of providing primitive data about itself (e.g., CPU capability, memory capacity, connectivity information, etc.), while prime nodes have the further capability of acting as information services aggregators. In other words, prime nodes will receive primitive data from leaf nodes and/or aggregated data from other prime nodes. Furthermore, whereas the topology formation service described above is provided by the master node, a meta indexing service component of the information services is provided by the root node. In particular, the meta indexing service provides information about the roles of the prime nodes, as well as provides a registry service for the prime nodes.

As is the case for grid topology formation, the information services topology is created in accordance with a predefined policy. In an exemplary embodiment, a policy concerning information services includes the following considerations:

an indexing service topology determines the scheme of data collection and distribution;

each grid node is responsible for collecting primitive data;

each grid node submits its primitive data to the primes that have subscribed to that data type

each prime is responsible for subscribing to its assigned data type to either grid nodes or other primes;

primitive system data is updated based on a pre-defined frequency or a pre-defined event;

system data aggregation is performed by the prime based on the policy assigned to that prime.

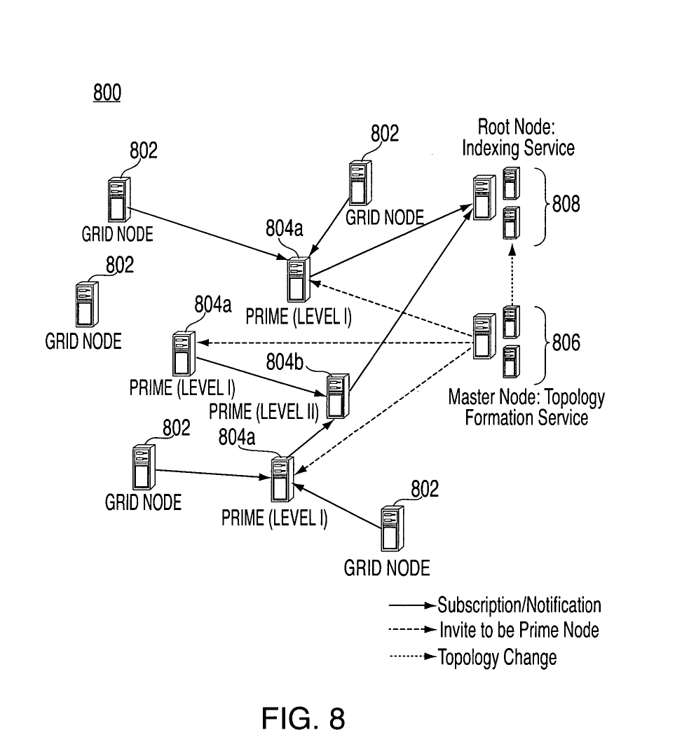

Referring now to FIG. 8, there is shown a schematic diagram of an exemplary information services topology 800 created in accordance with an embodiment of the invention. As is shown, the topology 800 includes a plurality of grid (leaf) nodes 802 that gather primitive information about themselves and provide such information to a prime node subscribing thereto. In FIG. 8, those prime nodes 804a that subscribe directly to grid nodes are designated as “Level I” primes, while those prime nodes 804b that subscribe to other prime nodes are designated as “Level II” primes. The master node 806 (which again is responsible for the grid topology formation service) determines which nodes serve as primes, while the root node 808 is responsible for the information indexing service, and is depicted as subscribing to both a Level I prime node 804a and a Level II prime node 804b. In the event of a grid topology change (such as a result of any of the conditions described earlier), the master node 806 informs the root node 808 of such change.

In operation, the master node 806 determines which nodes should be prime nodes, and informs those selected nodes (e.g., 804a and 804b) of their selection as indicated by the dashed arrows. The master node 806 also informs the other nodes on the list of grid nodes that the selected nodes must aggregate information therefrom. Furthermore, the master node also informs the root node 808 of this selection, as well as the list of primes to which the root node should subscribe. Each prime node subscribes to information received from the prescribed grid nodes, as indicated by the solid arrows. Each grid node (802) and each prime (804a, 804b) sends information (primitive or aggregated as the case may be) to the prime that subscribed to that corresponding information.

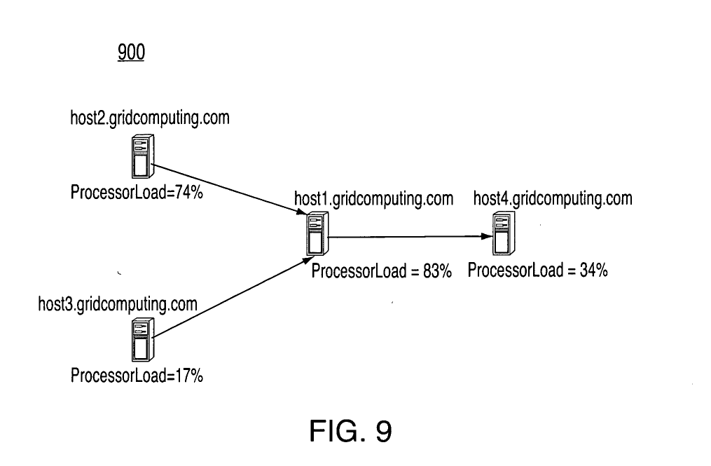

FIG. 9 is a schematic diagram 900 illustrating an example of the data aggregation capability of the information services topology. As is shown, host 1 receives node information (e.g., CPU load information) from host 2 and host 3. Host 1 therefore acts as a prime in this topology. Furthermore, host 2 is currently operating at a processor load capacity of 74%, while host 3 is currently operating at a processor load capacity of 17%. In addition, host 1 is also aware of its own processor load capacity (83% in the example depicted). The XML text below illustrates primitive data (such as recent processor load capacity and available RAM) that might be provided by host 1:

<?xml version=“1.0” encoding=“UTF-8”?>
<Host xmlns=“http://gridcomputing.com/Infoservice”>

<Hostname>host1.gridcomputing.com</Hostname>

<Memory RAMAvailable=“510” RAMSize=“1024” unit=
“MB”/>
<ProcessorLoad Last5Min=“83” unit=“percentage”/>

</Host>

In addition to having its own primitive data, host 1 will also have aggregated data pertaining to leaf nodes host 2 and host 3. For example, with regard to processor load capacity, host 1 can track which nodes are operating within a specified range of CPU load capacity. The granularity of the aggregated data at a given level can be predefined by the information services topology. Thus, host 1 could provide information on which nodes are operating between, for example, 0-25% CPU capacity, 26-50% CPU capacity, 51-75% CPU capacity, ad 76-100% CPU capacity. For this level of granularity, host 1 can report that there is one node operating at 0-25% CPU capacity (host 3), no nodes operating at 26-50% CPU capacity, one node operating at 51-75% CPU capacity (host 2), and one node operating at 76-100% CPU capacity (host 1). Moreover, host 1 may be configured to subscribe to host 2 and host 3 in a manner that host 1 is only notified of an update in CPU load capacity from host 2 or host 3 if there change in the specified range of load capacity. For instance, if the processor load of host 3 were to increase from 17% to 20%, then host 1 would not be notified since the value is still within the specified 0-25% CPU capacity range. On the other hand, if the processor load of host 3 were to increase from 17% to 27%, then host 1 would be notified since the value is now within the 26-50% CPU capacity range.

A further level of data aggregation is implemented at host 4. In addition to the primitive data concerning host 4, host 4 can subscribe to host 1 at a coarser level of granularity with respect to the CPU capacity information. For example, host 4 can be notified by host 1 as to the number of machines operating in the 0-50% CPU capacity range and the 51-100% CPU capacity range. An update to this information would only be received at host 4 if one or more of the nodes'CPU capacity changed from 0-50% to 51-100% or vice versa. The XML text below illustrates the characteristics of the exemplary aggregated data at host 4:

<?xml version=“1.0” encoding=“UTF-8” ?22
<AggregatedInformation xmlns=“http://gridcomputing.com/infoservice”>

<AttributeList>

<AttributeInfo name=“ProcessorLoad” unit=“percentage”/>

<TotalCount>4</TotalCount>
<PartitionInfo>

<Range low=“0” high=“50” />
<HostInfo>

<Hostname>host3.gridcomputing.com/infoservice</Hostname>
<Provider>host1.gridcomputing.com/primelevel1service</Provider>

</HostInfo>
<HostInfo>

<Hostname>host4.gridcomputing.com</Hostname>
<Provider>host4.gridcomputing.com/infoservice</Provider>

</HostInfo>

</PartitionInfo>
<PartitionInfo>

<Range low=“51” high=“100” />

<HostInfo>

<Hostname>host1.gridcomputing.com</Hostname>
<Provider>host1.gridcomputing.com/infoservice</Provider>

</HostInfo>
<HostInfo>

<Hostname>host2.gridcomputing.com/infoservice</Hostname>
<Provider>host1.gridcomputing.com/primelevel1service</Provider>

</HostInfo>
</PartitionInfo>

<AttributeInfo>

</AttributeList>

</AggregatedInformation>

As shown from the above, the aggregated data reflects that for the specified CPU load range of 0-50%, host 3 falls within this range (with the information being provided by host 1 at the first level of aggregation). Host 4 also falls within this range (with the information being provided by host 4 itself). For the specified CPU load range of 51-100%, host 4 is made aware that host 1 falls within this range (as directly provided by host 1), and that host 2 also falls within this range (as provided by host 1 at the first level of aggregation). Moreover, each prime node is aware of its aggregation level and position in the tree (grid structure), due to the root prime.

In addition to the number of nodes operating at a specified parameter range, the information service associated with each prime provides information about where to find the machines. For example, host 4 indicates that of two machines that have a CPU load range of 0-50%, one of those may be located through host 1 (which in turn identifies host 3), and the other being itself.

Finally, since each prime registers its own information (coming from its local information providers) along with the aggregate information, it is desirable to ensure that the tree of prime information services does not become too unbalanced. In other words, the topology may be configured such that there are no more than one or two depth levels of difference between all the resources in the information aggregated by any given prime. Otherwise, too much precision could be lost in the case of completely unbalanced trees.

The master node relies on a policy in order to make the selection of the primes and their roles. This policy takes into consideration certain factors directly related to information gathering and aggregation, above and beyond the factors of the availability and overload of the nodes selected to be primes. An advantage of this policy is the balancing of the information gathering cost with the request processing cost. The information gathering cost is based on the network and computational resources spent in performing the gathering and aggregation operations. This cost includes, among other factors: the number of notification for data change on the network, the size of this update, the size of cache in primes, and the network characteristics between a prime and its children.

The request processing cost in turn depends on the number of queries that is generated for a given request for information from the system, and the cost in executing these queries by the primes. An exemplary policy based on request processing cost may be as follows: (1) if the average number of queries/request is greater than a threshold then a finer grained range for the involved data type is needed; (2) if the average number of queries/request is less than a low-mark threshold then a coarser grained range for that data type is needed. For both of these conditions, the master node would decide if a topology change and reselection of the primes and their roles is warranted.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for information gathering and aggregation in a dynamic distributed environment comprising a topology of topology nodes, and information aggregation comprising any one of analyzing or condensing gathered information, the method comprising the steps of:
obtaining topology information, the topology information identifying a plurality of topology nodes of the topology and communication paths of the plurality of topology nodes;
obtaining an information services policy;
determining information gathering directives for information gathering nodes included in the plurality of topology nodes, based on the obtained topology information and the obtained information services policy;
determining information aggregating directives for information aggregating nodes included in the plurality of topology nodes, based on the obtained topology information and the obtained information services policy;
sending the information gathering directives to the information gathering nodes of the plurality of topology nodes; and
sending the information aggregating directives to the information aggregating nodes of the plurality of topology nodes.

2. The method of claim, further comprising periodically updating the topology information.

3. The method of claim 2, wherein the topology information is updated due to any one of a change of nodes of the topology, a change of communication paths of the topology or a detected failure of an aggregating node, the detected failure triggering the selection of a substitute aggregating node.

4. The method of claim 1, wherein the topology nodes further comprise:
one or more leaf nodes having only incoming edges thereto, at least one of the one or more leaf nodes configured to collect information about itself;
one or more prime nodes having both incoming and outgoing edges, at least of the one or more prime nodes configured to aggregate the information received from other topology nodes to which the configured prime node subscribes; and
one or more root nodes having only outgoing edges, at least one of the one or more root nodes configured to aggregate information received from other topology nodes to which the configured root node subscribes.

5. The method of claim 1, wherein aggregation comprises one or more of any one of:
assigning ranges of values and categorizing a given node based on the range into which the value reported by the given node falls;
rounding the values reported by the given node into coarser ranges;
eliminating information that does not change from previously reported values thereof; or
categorizing nodes into categories rather than reporting the corresponding information values.

6. The method of claim 1, wherein data gathering comprises one or more of any one of:
subscribing for notification of information from one or more nodes when the value of the information changes by a policy-specified amount;
subscribing for periodic notification of the information from the one or more nodes; or
querying the one or more nodes for specific up to date information.

7. The method of claim 4, wherein the information collected includes any one of CPU usage or memory.

8. The method of claim 1, wherein the information services policy comprises one or more of any one of:
maintaining a balance between information gathering cost and information querying cost, by making the aggregation ranges coarser or finer; or
ensuring that prime nodes spend less than a predefined proportion of their resources for the tasks of information aggregation by creating new prime nodes and distributing the information gathering load to the created new prime nodes.

9. The method of claim 1, further comprising:
receiving a communication from an entity, the communication including a topology event notification indicating an event affecting the topology;
determining with an automated topology formation application that the topology event notification affects a topology portion of the topology; and
based on the topology event notification, modifying the affected topology portion of the topology according to a predefined topology policy definition.

10. The method of claim 9, wherein the topology event notification is initiated by an aggregating node detecting a need for a topology change.

11. The method of claim 4, wherein a first of the prime nodes subscribes directly to at least one of the one or more leaf nodes, and aggregates information therefrom at a first level of granularity.

12. The method of claim 11, wherein a second of the prime nodes subscribes directly to at least another of the one or more prime nodes, and aggregates information therefrom at a second desired level of granularity.

13. The method of claim 12, wherein the second level of granularity is coarser than the first level of granularity.

14. The method of claim 4, wherein the master node is configured to notify the root node of any change in the topology.

15. The method of claim 4, wherein information aggregated by at least one of the one or more prime nodes is updated based upon any one of a predefined frequency or a predefined event.

16. The method of claim 4, wherein said root node provides a meta indexing service component of the information services policy.

17. The method of claim 16, wherein the meta indexing service component provides information of the roles of the prime nodes and provides a registry service for the prime nodes.

18. The method of claim 1, further comprising the steps of:
configuring a master node in the topology, the master node further comprising an automated topology formation application having a predefined topology policy definition and a representation of the topology, wherein the topology comprises nodes and intercommunication paths between the nodes, the nodes further comprising:
one or more leaf nodes having only incoming edges thereto, one or more of the one or more leaf node configured to collect information about itself;
one or more prime nodes having both incoming and outgoing edges, one or more of the one or more prime nodes configured to information received from other nodes to which each said prime node subscribes, based on a predefined information services policy; and
one or more root prime nodes having only outgoing edges, one or more of the one or more root prime nodes configured to aggregate and index information received from other nodes to which each said root prime node subscribes;
the master node further comprising an automated topology formation application having a predefined topology policy definition and a representation of the active topology;
transmitting collected information from a configured leaf node to a subscribing prime node, the collected information collected according to a collecting directive, the transmitting performed according to a predetermined schedule;
receiving the transmitted collected information at a first configured prime node and aggregating the received collected information with collected information received from one or more other configured leaf nodes;
when the first configured prime node is subscribed to by a second configured prime node, transmitting the aggregated information to the second configured prime node according to a predetermined schedule;
when the first configured prime node is subscribed to by a second configured prime node, aggregating at the second configured prime node the aggregated information with information received from other nodes subscribed to by the second configured prime node;
when an aggregating step detects a predefined topology affecting event, transmitting a topology event notification to the master node, the event notification indicating an event affecting the active topology;
determining with the automated topology formation application that the topology event notification affects a topology portion of the active topology; and
based on the topology event notification, modifying the representation of the affected topology portion of the active topology according to the predefined topology policy definition.

19. A method for information gathering and aggregation in a dynamic distributed environment comprising an active topology of topology nodes, and information aggregation comprising one or more of analyzing or condensing gathered information, the method comprising the steps of:
configuring a master node in the active topology, the master node comprising an automated topology formation application having a predefined topology policy definition and a representation of the active topology, wherein the active topology comprises nodes and intercommunication paths between the nodes, the nodes further comprising:
one or more leaf nodes having only incoming edges thereto, one or more of the one or more leaf node configured to collect information about itself;
one or more prime nodes having both incoming and outgoing edges, one or more of the one or more prime nodes configured to information received from other nodes to which each said prime node subscribes, based on a predefined information services policy; and
one or more root prime nodes having only outgoing edges, one or more of the one or more root prime nodes configured to aggregate and index information received from other nodes to which each said root prime node subscribes;
transmitting collected information from a configured leaf node to a subscribing prime node, the collected information collected according to a collecting directive, the transmitting performed according to a predetermined schedule;
receiving the transmitted collected information at a first configured prime node and aggregating the received collected information with collected information received from one or more other configured leaf nodes;
when the first configured prime node is subscribed to by a second configured prime node, transmitting the aggregated information to the second configured prime node according to a predetermined schedule;
when the first configured prime node is subscribed to by a second configured prime node, aggregating at the second configured prime node the aggregated information with information received from other nodes subscribed to by the second configured prime node;
when an aggregating step detects a predefined topology affecting event, transmitting a topology event notification to the master node, the event notification indicating an event affecting the active topology;
determining with the automated topology formation application that the topology event notification affects a topology portion of the active topology; and
based on the topology event notification, modifying the representation of the affected topology portion of the active topology according to the predefined topology policy definition.

20. The method of claim 19, wherein the active topology information is modified due to any one of a change of nodes of the topology, a change of intercommunication paths of the topology or a detected failure of an aggregating node the detected failure triggering the selection of a substitute aggregating node.

21. The method of claim 20, further comprising substituting a new aggregating node of the topology upon detection of a failed aggregating node of the topology.

22. The method of claim 19, wherein aggregation comprises one or more of any one of:
assigning ranges of values and categorizing a given node based on the range into which the value reported by the given node falls;
rounding the values reported by the given node into coarser ranges;
eliminating information that does not change from previously reported values thereof; or
categorizing nodes into categories rather than reporting the corresponding information values.

23. The method of claim 19, wherein data gathering comprises one or more of:
subscribing for notification of information from one or more nodes when the value of the information changes by a policy-specified amount;
subscribing for periodic notification of the information from the one or more nodes; or
querying the one or more nodes for specific up to date information.

24. The method of claim 23, wherein the information collected includes any one of CPU usage or memory.

25. The method of claim 19, wherein the information services policy comprises one or more of any one of:
maintaining a balance between information gathering cost and information querying cost, by making the aggregation ranges coarser or finer; or
ensuring that prime nodes spend less than a predefined proportion of their resources for the tasks of information aggregation by creating new prime nodes and distributing the information gathering load to the created new prime nodes.

26. The method of claim 19, wherein a first of the prime nodes subscribes directly to at least one of the one or more leaf nodes, and aggregates information therefrom at a first level of granularity.

27. The method of claim 26, wherein a second of the prime nodes subscribes directly to at least another of the one or more prime nodes, and aggregates information therefrom at a second desired level of granularity.

28. The method of claim 27, wherein the second level of granularity is coarser than the first level of granularity.

29. The method of claim 19, wherein the master node is configured to notify the root node of any change in the topology.

30. The method of claim 19, wherein information aggregated by at least one of the one or more prime nodes is updated based upon any one of: a predefined frequency or a predefined event.

31. The method of claim 19, wherein said root node provides a meta indexing service component of the information services policy.

32. The method of claim 31, wherein the meta indexing service component provides information of the roles of the prime nodes and provides a registry service for the prime nodes.

33. The method of claim 19, further comprising distributing any one of aggregating directives or collecting directives to any one of one or more configured leaf nodes or one or more configured prime nodes.

34. A computer program product for information gathering and aggregation in a dynamic distributed environment comprising a topology of topology nodes, and information aggregation comprising any one of analyzing or condensing gathered information, comprising:
a storage medium readable by a processing circuit, the storage medium comprising machine readable computer program code including instructions for causing the processing circuit to implement a method, the method further comprising the steps of:
obtaining topology information, the topology information identifying a plurality of topology nodes of the topology and communication paths of the plurality of topology nodes;
obtaining an information services policy;
determining information gathering directives for information gathering nodes included in the plurality of topology nodes, based on the obtained topology information and the obtained information services policy;
determining information aggregating directives for information aggregating nodes included in the plurality of topology nodes, based on the obtained topology information and the obtained information services policy;
sending the information gathering directives to the information gathering nodes of the plurality of topology nodes; and
sending the information aggregating directives to the information aggregating nodes of the plurality of topology nodes.

35. The computer program product of claim 34, wherein the topology nodes further comprise:
one or more leaf nodes having only incoming edges thereto, at least one of the one or more leaf nodes configured to collect information about itself;
one or more prime nodes having both incoming and outgoing edges, at least of the one or more prime nodes configured to aggregate the information received from other topology nodes to which the configured prime node subscribes; and
one or more root nodes having only outgoing edges, at least one of the one or more root nodes configured to aggregate information received from other topology nodes to which the configured root node subscribes.

36. The computer program product of claim 34, wherein:
aggregation comprises one or more of any one of:
assigning ranges of values and categorizing a given node based on the range into which the value reported by the given node falls;
rounding the values reported by the given node into coarser ranges;
eliminating information that does not change from previously reported values thereof; or
categorizing nodes into categories rather than reporting the corresponding information values; and
data gathering comprises one or more of any one of:
subscribing for notification of information from one or more nodes when the value of the information changes by a policy-specified amount;
subscribing for periodic notification of the information from the one or more nodes; or
querying the one or more nodes for specific up to date information.

37. The computer program product of claim 34, further comprising:
receiving a communication from an entity, the communication including a topology event notification indicating an event affecting the topology;
determining with an automated topology formation application that the topology event notification affects a topology portion of the topology; and
based on the topology event notification, modifying the affected topology portion of the topology according to a predefined topology policy definition.

38. The computer program product of claim 34, further comprising the steps of:
configuring a master node in the topology, the master node further comprising an automated topology formation application having a predefined topology policy definition and a representation of the topology, wherein the topology comprises nodes and intercommunication paths between the nodes, the nodes further comprising:
one or more leaf nodes having only incoming edges thereto, one or more of the one or more leaf node configured to collect information about itself;
one or more prime nodes having both incoming and outgoing edges, one or more of the one or more prime nodes configured to information received from other nodes to which each said prime node subscribes, based on a predefined information services policy; and
one or more root prime nodes having only outgoing edges, one or more of the one or more root prime nodes configured to aggregate and index information received from other nodes to which each said root prime node subscribes;
the master node further comprising an automated topology formation application having a predefined topology policy definition and a representation of the active topology;
transmitting collected information from a configured leaf node to a subscribing prime node, the collected information collected according to a collecting directive, the transmitting performed according to a predetermined schedule;
receiving the transmitted collected information at a first configured prime node and aggregating the received collected information with collected information received from one or more other configured leaf nodes;
when the first configured prime node is subscribed to by a second configured prime node, transmitting the aggregated information to the second configured prime node according to a predetermined schedule;
when the first configured prime node is subscribed to by a second configured prime node, aggregating at the second configured prime node the aggregated information with information received from other nodes subscribed to by the second configured prime node;
when an aggregating step detects a predefined topology affecting event, transmitting a topology event notification to the master node, the event notification indicating an event affecting the active topology;
determining with the automated topology formation application that the topology event notification affects a topology portion of the active topology; and
based on the topology event notification, modifying the representation of the affected topology portion of the active topology according to the predefined topology policy definition.

39. A computer program product for information gathering and aggregation in a dynamic distributed environment comprising a topology of topology nodes, and information aggregation comprising any one of analyzing or condensing gathered information, comprising:
a storage medium readable by a processing circuit, the storage medium comprising machine readable computer program code including instructions for causing the processing circuit to implement a method, the method further comprising the steps of:
configuring a master node in the active topology, the master node comprising an automated topology formation application having a predefined topology policy definition and a representation of the active topology, wherein the active topology comprises nodes and intercommunication paths between the nodes, the nodes further comprising:
one or more leaf nodes having only incoming edges thereto, one or more of the one or more leaf node configured to collect information about itself;
one or more prime nodes having both incoming and outgoing edges, one or more of the one or more prime nodes configured to information received from other nodes to which each said prime node subscribes, based on a predefined information services policy; and
one or more root prime nodes having only outgoing edges, one or more of the one or more root prime nodes configured to aggregate and index information received from other nodes to which each said root prime node subscribes;
transmitting collected information from a configured leaf node to a subscribing prime node, the collected information collected according to a collecting directive, the transmitting performed according to a predetermined schedule;
receiving the transmitted collected information at a first configured prime node and aggregating the received collected information with collected information received from one or more other configured leaf nodes;
when the first configured prime node is subscribed to by a second configured prime node, transmitting the aggregated information to the second configured prime node according to a predetermined schedule;
when the first configured prime node is subscribed to by a second configured prime node, aggregating at the second configured prime node the aggregated information with information received from other nodes subscribed to by the second configured prime node;
when an aggregating step detects a predefined topology affecting event, transmitting a topology event notification to the master node, the event notification indicating an event affecting the active topology;
determining with the automated topology formation application that the topology event notification affects a topology portion of the active topology; and
based on the topology event notification, modifying the representation of the affected topology portion of the active topology according to the predefined topology policy definition.

40. The computer program product of claim 39, wherein:
aggregation comprises one or more of any one of:
assigning ranges of values and categorizing a given node based on the range into which the value reported by the given node falls;
rounding the values reported by the given node into coarser ranges;
eliminating information that does not change from previously reported values thereof; or
categorizing nodes into categories rather than reporting the corresponding information values; and
data gathering comprises one or more of any one of:
subscribing for notification of information from one or more nodes when the value of the information changes by a policy-specified amount;
subscribing for periodic notification of the information from the one or more nodes; or
querying the one or more nodes for specific up to date information.

41. A system for information gathering and aggregation in a dynamic distributed environment comprising a topology of topology nodes, and information aggregation comprising any one of analyzing or condensing gathered information, comprising:
a network;
a first computer system in communication with the network, wherein the first computer system includes instructions for implementing a method, the method further comprising:
a storage medium readable by a processing circuit, the storage medium comprising machine readable computer program code including instructions for causing the processing circuit to implement a method, the method further comprising the steps of:
obtaining topology information, the topology information identifying a plurality of topology nodes of the topology and communication paths of the plurality of topology nodes;
obtaining an information services policy;
determining information gathering directives for information gathering nodes included in the plurality of topology nodes, based on the obtained topology information and the obtained information services policy;
determining information aggregating directives for information aggregating nodes included in the plurality of topology nodes, based on the obtained topology information and the obtained information services policy;
sending the information gathering directives to the information gathering nodes of the plurality of topology nodes; and
sending the information aggregating directives to the information aggregating nodes of the plurality of topology nodes.

42. The system of claim 41, wherein the topology nodes further comprise:
one or more leaf nodes having only incoming edges thereto, at least one of the one or more leaf nodes configured to collect information about itself;
one or more prime nodes having both incoming and outgoing edges, at least of the one or more prime nodes configured to aggregate the information received from other topology nodes to which the configured prime node subscribes; and
one or more root nodes having only outgoing edges, at least one of the one or more root nodes configured to aggregate information received from other topology nodes to which the configured root node subscribes.

43. The system of claim 41, wherein:
aggregation comprises one or more of any one of:
assigning ranges of values and categorizing a given node based on the range into which the value reported by the given node falls;
rounding the values reported by the given node into coarser ranges;
eliminating information that does not change from previously reported values thereof; or
categorizing nodes into categories rather than reporting the corresponding information values; and
data gathering comprises one or more of any one of:
subscribing for notification of information from one or more nodes when the value of the information changes by a policy-specified amount;
subscribing for periodic notification of the information from the one or more nodes; or
querying the one or more nodes for specific up to date information.

44. The system of claim 41, further comprising:
receiving a communication from an entity, the communication including a topology event notification indicating an event affecting the topology;
determining with an automated topology formation application that the topology event notification affects a topology portion of the topology; and
based on the topology event notification, modifying the affected topology portion of the topology according to a predefined topology policy definition.

45. The system of claim 41, further comprising the steps of:
configuring a master node in the topology, the master node further comprising an automated topology formation application having a predefined topology policy definition and a representation of the topology, wherein the topology comprises nodes and intercommunication paths between the nodes, the nodes further comprising:
one or more leaf nodes having only incoming edges thereto, one or more of the one or more leaf node configured to collect information about itself;
one or more prime nodes having both incoming and outgoing edges, one or more of the one or more prime nodes configured to information received from other nodes to which each said prime node subscribes, based on a predefined information services policy; and
one or more root prime nodes having only outgoing edges, one or more of the one or more root prime nodes configured to aggregate and index information received from other nodes to which each said root prime node subscribes;
the master node further comprising an automated topology formation application having a predefined topology policy definition and a representation of the active topology;
transmitting collected information from a configured leaf node to a subscribing prime node, the collected information collected according to a collecting directive, the transmitting performed according to a predetermined schedule;
receiving the transmitted collected information at a first configured prime node and aggregating the received collected information with collected information received from one or more other configured leaf nodes;
when the first configured prime node is subscribed to by a second configured prime node, transmitting the aggregated information to the second configured prime node according to a predetermined schedule;
when the first configured prime node is subscribed to by a second configured prime node, aggregating at the second configured prime node the aggregated information with information received from other nodes subscribed to by the second configured prime node;
when an aggregating step detects a predefined topology affecting event, transmitting a topology event notification to the master node, the event notification indicating an event affecting the active topology;
determining with the automated topology formation application that the topology event notification affects a topology portion of the active topology; and
based on the topology event notification, modifying the representation of the affected topology portion of the active topology according to the predefined topology policy definition.

46. A system for information gathering and aggregation in a dynamic distributed environment comprising a topology of topology nodes, and information aggregation comprising any one of analyzing or condensing gathered information, comprising:
a network;
a first computer system in communication with the network, wherein the first computer system includes instructions for implementing a method, the method further comprising:
configuring a master node in the active topology, the master node comprising an automated topology formation application having a predefined topology policy definition and a representation of the active topology, wherein the active topology comprises nodes and intercommunication paths between the nodes, the nodes further comprising:
one or more leaf nodes having only incoming edges thereto, one or more of the one or more leaf node configured to collect information about itself;
one or more prime nodes having both incoming and outgoing edges, one or more of the one or more prime nodes configured to information received from other nodes to which each said prime node subscribes, based on a predefined information services policy; and
one or more root prime nodes having only outgoing edges, one or more of the one or more root prime nodes configured to aggregate and index information received from other nodes to which each said root prime node subscribes;
transmitting collected information from a configured leaf node to a subscribing prime node, the collected information collected according to a collecting directive, the transmitting performed according to a predetermined schedule;
receiving the transmitted collected information at a first configured prime node and aggregating the received collected information with collected information received from one or more other configured leaf nodes;
when the first configured prime node is subscribed to by a second configured prime node, transmitting the aggregated information to the second configured prime node according to a predetermined schedule;
when the first configured prime node is subscribed to by a second configured prime node, aggregating at the second configured prime node the aggregated information with information received from other nodes subscribed to by the second configured prime node;
when an aggregating step detects a predefined topology affecting event, transmitting a topology event notification to the master node, the event notification indicating an event affecting the active topology;
determining with the automated topology formation application that the topology event notification affects a topology portion of the active topology; and
based on the topology event notification, modifying the representation of the affected topology portion of the active topology according to the predefined topology policy definition.

47. The system of claim 36, wherein:
aggregation comprises one or more of any one of:
assigning ranges of values and categorizing a given node based on the range into which the value reported by the given node falls;
rounding the values reported by the given node into coarser ranges;
eliminating information that does not change from previously reported values thereof; or
categorizing nodes into categories rather than reporting the corresponding information values; and
data gathering comprises one or more of any one of:
subscribing for notification of information from one or more nodes when the value of the information changes by a policy-specified amount;
subscribing for periodic notification of the information from the one or more nodes; or
querying the one or more nodes for specific up to date information.

48. A service for information gathering and aggregation in a dynamic distributed environment comprising a topology of intercommunicating topology nodes, wherein aggregating comprises any one of analyzing or condensing gathered information, the topology comprising:
one or more leaf nodes having only incoming edges thereto, one or more of the one or more leaf node configured to collect information about itself;
one or more prime nodes having both incoming and outgoing edges, one or more of the one or more prime nodes configured to information received from other nodes to which each said prime node subscribes, based on a predefined information services policy, wherein the topology comprises a hierarchy of one or more prime nodes; and
one or more root prime nodes having only outgoing edges, one or more of the one or more root prime nodes configured to aggregate and index information received from other nodes to which each said root prime node subscribes;
the service comprising:
configuring a master node to manage the topology;
providing any one of information gathering directives and information aggregating directives to the topology nodes, the directives based on an information services policy wherein any one of information gathered or aggregated information is aggregated at aggregating nodes;
in response to an event notification received at the master node, modifying a portion of the topology wherein an event notification is signaled when any one of a node is added to the topology, a node is removed from the topology, a node fails, an aggregator requests a topology change or an application requests a topology change, wherein further the modification of the portion of the topology comprises any one of modifying a topology node intercommunication path, adding a node, removing a node, modifying the information gathering directive of a node, notifying an application of the event notification or modifying the information aggregating directive of a node.
